(19) United States
(12) Patent Application Publication
(10) Pub. No.: US 2010/0096582 A1
(43) Pub. Date: Apr. 22, 2010

(54) Magnetic rubber composition for encoder

(76) Inventor: Yoshihiko Yamaguchi, Okayama (JP)

Correspondence Address: WENDEROTH, LIND & PONACK, L.L.P., 1030 15th Street, N.W.,, Suite 400 East, Washington, DC, 20005-1503, US

(21) Appl. No.: 12/654,290

(22) Filed: Dec. 16, 2009

Related U.S. Application Data
(63) Continuation of application No. 12/314,013, filed on Dec. 2, 2008.
Application No. 12/314,013 is a continuation of application No. 12/003,483, filed on Dec. 26, 2007, now abandoned.
Application No. 12/003,483 is a continuation of application No. 11/709,810, filed on Feb. 23, 2007, now abandoned.
Application No. 11/709,810 is a continuation of application No. 11/389,256, filed on Mar. 27, 2006, now abandoned.
Application No. 11/389,256 is a continuation of application No. 10/900,318, filed on Jul. 28, 2004, now abandoned.
Application No. 10/900,318 is a continuation of application No. 09/890,189, filed on Jul. 30, 2001, now abandoned.

(30) Foreign Application Priority Data
Nov. 30, 1999 (JP) 11-340227
Dec. 13, 1999 (JP) 11-353051

(51) Int. Cl. H01F 1/147

(52) U.S. Cl. 252/62.54

(57) ABSTRACT

A magnetic rubber composition for encoder having a magnetic characteristic in sufficient application range, used as encoder after magnetization as well as heat resistance, water resistance and oil resistance required for use as encoder, and excellent processing property, and capable of being bonded by vulcanization with a metal, is provided. Furthermore, a magnetic rubber composition for encoder capable of obtaining sufficient magnetic force required for encoder on a circumference of the molded encoder as well as capable of effectively restraining variation of the level of magnetic force, is provided. It is provided by comprising 300 to 1,800 parts of strontium-ferrite, or 300 to 1,800 parts of barium-ferrite, or 300 to 1,800 parts of a mixture of strontium-ferrite and barium-ferrite, 0.5 to 2 parts of silane coupling agent, and 1 to 10 parts of lubricating agent, per 100 parts of a hydrogenated nitrile butadiene rubber with 15 to 50% of acrylonitrile amount and 80 to 99% of hydrogenation ratio.

### TECHNICAL FIELD

The present invention relates to magnetic rubber compositions for encoder, to be adopted in rotation sensor for detecting rotation speed of wheel shaft of, for example, automobile. Such magnetic rubber compositions are magnetized and then used as encoder. The present invention relates to magnetic rubber compositions for encoder after magnetization having magnetic force characteristic, heat resistance, water resistance and oil resistance required for using as encoder, excellent processing property, and capable of being bonded by vulcanization with metal. Furthermore, the present invention relates to magnetic rubber compositions for encoder which are obtained sufficient magnetic force required for encoder on the circumference of the molded encoder as well as capable of effectively restraining variation of the level of magnetic force.

### BACKGROUND ART

Conventionally, rubbers are said to be inferior to heat resistance, water resistance, oil resistance and rubber elasticity is lost after long use under 130 to 150° C. environment, in genera. For overcoming these disadvantages; hydrogenated nitrile butadiene rubber has been developed.

In order to give magnetism to hydrogenated nitrile butadiene rubber, it is necessary to add rare earth, ferrite, or the like as magnetic powder to the hydrogenated nitrile butadiene rubber. Ferrite is commonly used because of high cost and poor kneading operativity of rare earth. Here, barium group and strontium group are used commonly as ferrite for giving magnetism to the rubber, but since the mixing amount of ferrite create problems described after, strontium group ferrite which has larger magnetic force than barium group ferrite is advantage of use.

In order to give sufficient magnetic characteristic of practical use for encoder after magnetizing the hydrogenated nitrile butadiene rubber, it is necessary to mix a large amount of ferrite with hydrogenated nitrile butadiene rubber.

However, when a large amount of ferrite is mixed with hydrogenated nitrile butadiene rubber, durable strength for use cannot be ensured, physical properties such as stretchability and rubber elasticity are lowered, and thus the processing property is remarkably deteriorated. In contrast, when the various additives are mixed with the hydrogenated nitrile butadiene rubber composition for restoring the physical properties. deteriorated by a large amount use of ferrite, the magnetic characteristic is deteriorated and the vulcanization bonding property is lowered.

Therefore, in the case where ferrite is used for the purpose of giving of practical use of magnetic characteristic, various technological problems are involved.

The present invention is to provide a magnetic rubber composition for encoder after magnetization having a sufficient magnetic characteristic of practical use as well as heat resistance, water resistance and oil resistance required for encoder, excellent for processing property, and capable of being bonded by vulcanization with a metal. Furthermore, the present invention is also to provide a magnetic rubber composition for encoder capable of obtaining a sufficient magnetic force required for encoder on the circumference of molded encoder and effectively restraining variation of the level of magnetic force.

### DISCLOSURE OF THE INVENTION

As a result of studying a number of compositions and conducting magnetic properties tests by inventor, a magnetic rubber composition for encoder having a sufficient magnetic characteristic of practical use, excellent heat resistance and so on, and capable of being bonded by vulcanization with a metal was found out. And then the present invention has been achieved.

That is, a magnetic rubber composition for encoder according to the present invention is provided by comprising 300 to 1,800 parts of strontium-ferrite or 300 to 1,800 parts of barium-ferrite, 0.5 to 2 parts of silane coupling agent, and 1 to 10 parts of lubricating agent, each per 100 parts of hydrogenated nitrile butadiene rubber with 15 to 50% of acrylonitrile amount and 80 to 99% of hydrogenation ratio.

In the present invention, the hydrogenated nitrile butadiene rubber with 15 to 50% of acrylonitrile amount and 80 to 99% of hydrogenation ratio is used, because this polymer has excellent for heat resistance and particularly, stretch change ratio compared with conventional nitrile butadiene rubber, and superior in water resistance and grease resistance compared with acrylic rubber. The hydrogenated nitrile butadiene rubber with 15 to 50% of acrylonitrile amount and 80 to 99% of hydrogenation ratio which is obtained by ordinary method can be used.

In the present invention, commercially available strontium-ferrite and barium-ferrite can be used, but from the viewpoint of excellent magnetic characteristic, a preferable average particle size of these ferrites is 0.9 to 1.4 μm and wide particle distribution is preferable.

The magnetic characteristic of magnetic rubber for encoder according to the present invention varies largely with content ratio of ferrites.

In the present invention, excellent magnetic characteristic can be provided, in the case where only strontium-ferrite is mixed as magnetic powder. In this case, strontium-ferrite is mixed with 300 to 1,800 parts per 100 parts of hydrogenated nitrile butadiene rubber. The amount of strontium-ferrite is less than 300 parts per 100-parts of hydrogenated nitrile butadiene rubber, magnetic characteristic required for encoder may not be obtained. In contrast, it is more than 1,800 parts, the processing operation becomes more difficult to be executed, the rubber physical characteristic is lowered, and besides, the bonding property to metal is deteriorated.

Regular magnetic pole can be obtained, in the case where only barium-ferrite is mixed as magnetic powder. In this case, barium-ferrite is mixed with 300 to 1,800 parts per 100 parts of hydrogenated nitrile butadiene rubber. The amount of barium-ferrite is less than 300 parts per 100 parts of the hydrogenated nitrile butadiene rubber, magnetic characteristic required for encoder may not be obtained. In contrast, it is more than 1,800 parts, the processing operation becomes more difficult to be executed, the rubber physical characteristic is lowered, and besides, the bonding property to metal is deteriorated.

In the present invention, silane coupling agent is mixed for the purpose of not only improving rubber physical characteristic but also improving reinforcing effect for linking function with polymer and interaction between ferrite and polymer.

As the silane coupling agent, for example, mercaptosilane can be used. The silane coupling agent is mixed with 0.5 to 2 parts per 100 parts of hydrogenated nitrile butadiene rubber. The amount of silane coupling agent is less than 0.5 parts per 100 parts of hydrogenated nitrile butadiene rubber, additive effect of silane coupling agent may not be obtained sufficiently. In contrast, it is more than 2 parts, vulcanization speed is increased, causing deterioration of moldability.

In the present invention, by mixing lubricating agent, processing property, in particular, kneading property is improved without influencing bonding property.

As the lubricating agent, for example, microcrystalline wax and paraffin wax can be used. The lubricating agent is mixed with 1 to 10 parts per 100 parts of hydrogenated nitrile butadiene rubber. The amount of lubricating agent is less than 1 part per 100 parts of the hydrogenated nitrile butadiene rubber, it is insufficient for improving the processing property. In contrast, it is more than 10 parts, it is adversely affected by rubber characteristic and vulcanization bonding property. It is further preferable to add lubricating agent: with 1 to 5 parts per 100 parts of hydrogenated nitrile butadiene rubber on the point of improving the processing property and further reducing the influence of rubber characteristic and vulcanization bonding property as much as possible.

The inventor found out that a sufficient magnetic force required for encoder can be obtained on the circumference of encoder, and variation of magnetic force can effectively be restrained by blending barium-ferrite and strontium-ferrite. And then the present invention has been achieved.

That is, another magnetic rubber composition for encoder according to the present invention is provided by comprising 300 to 1,800 parts of a mixture of strontium-ferrite and barium-ferrite, 0.5 to 2 parts of silane coupling agent, and 1 to 10 parts of lubricating agent, per 100 parts of hydrogenated nitrile butadiene rubber with 15 to 50% of acrylonitrile amount and 80 to 99% of hydrogenation ratio.

By mixing the mixture of strontium-ferrite and barium-ferrite with hydrogenated nitrile butadiene rubber, molding operation can be executed in the same manner as conventional rubber products, almost same magnetic force in the case of mixing only strontium-ferrite as magnetic powder can be obtained, and variation of magnetic force can effectively be restrained on the circumference of molded encoder.

The mixture of strontium-ferrite and barium-ferrite is mixed with 300 to 1,800 parts per 100 parts of hydrogenated nitrile butadiene rubber. The amount of the mixture of strontium-ferrite and barium-ferrite is less than 300 parts per 100 parts of hydrogenated nitrile butadiene rubber, magnetic characteristic required for encoder may not be obtained. In contrast, it is more than 1,800 parts, the processing operation becomes more difficult to be executed, rubber physical characteristic is lowered, and besides, bonding property to metal is deteriorated.

It is preferable that 20 to 50% by weight of barium-ferrite is contained in the mixture of strontium-ferrite and barium-ferrite. In the mixture of strontium-ferrite and barium-ferrite, 20% by weight or more barium-ferrite is effective for restraining variation of magnetic force on the circumference of encoder. In contrast, it is more than 50% by weight, the physical property required for magnetic rubber for encoder may not be obtained, and thus it is not preferable.

Above-mentioned magnetic rubber composition for encoder according to the present invention with strontium-ferrite and barium-ferrite blended, silane coupling agent and lubricating agent are mixed for above-mentioned reason.

In any of above-mentioned magnetic rubber compositions for encoder according to the present invention, it is preferable to mix carbon black with hydrogenated nitrile butadiene rubber for increasing the mechanical strength of rubber composition of the present invention, and for improving the physical properties such as hardness and wear resistance.

As the carbon black, commercially available can be used, but it is preferable to use having a particle size of 10 to 50 nm. In general, particle size of carbon black is finer, the more reinforcing effect is increased, in contrast, the processing operation becomes more difficult to be executed. Moreover, Standard composition of carbon black is 40 to 60 parts per 100 parts of material rubber, but in the rubber composition according to the present invention, it is preferable to mix with 2 to 30 parts per 100 parts of hydrogenated nitrite butadiene rubber, because a large amount of carbon black deteriorates magnetic characteristic.

In the present invention, it is preferable to carry out vulcanization for improving the physical properties of the hydrogenated nitrile butadiene rubber.

In the present invention, as vulcanization agent to be mixed for executing the vulcanization, for example, sulfur, peroxide, or the like can be presented. In the case of peroxide is used as the vulcanization agent, co-crosslinking agent is mixed as well.

It is preferable to mix vulcanization agent with 0.1 to 10 parts per 100 parts of hydrogenated nitrile butadiene rubber. The amount of vulcanization agent is less than 0.1 part per 100 parts of hydrogenated nitrile butadiene rubber, the rubber physical property may not be improved, and thus it is not preferable. In contrast, it is more than 10 parts, the flexibility of vulcanized rubber may be deteriorated, and thus it is not preferable. In the case of sulfur vulcanization, it is further preferable to add vulcanization agent by 0.1 to 2 parts per 100 parts of hydrogenated nitrile butadiene rubber in order to obtain vulcanized rubber with further better flexibility while improving the rubber physical property.

In addition to vulcanization agent, in order to increase the vulcanization speed and improve the physical property of the vulcanized product, it is preferable to mix vulcanization promoting agent such as N-cyclohexyl benzothiazyl-2-sulfenamide (CM), tetramethyl thiuramdisulfide (TT), and N-(cyclohexyl thio) phthalimide (PVI), and vulcanization promoting auxiliary agent such as zinc oxide and stearic acid.

The bonding property to metal can further be improved by executing secondary vulcanization after vulcanization molding.

In the present invention, materials other than above-mentioned can be mixed as long as the effect of the present invention is not hindered. For example, antioxidant can be mixed by 1 to 5 parts per 100 parts of hydrogenated nitrile butadiene rubber in order to prevent the thermal deterioration, or plasticizer can be mixed by 1 to 20 parts per 100 parts of hydrogenated nitrile butadiene rubber in order to improve kneading property and extrusion property.

### BEST MODE FOR CARRYING OUT THE INVENTION

### Example 1

Using a hermetically sealed type kneading machine, with a temperature preset at 90° C., following materials were added and kneaded at one time.

Hydrogenated nitrile butadiene rubber (H-NBR) with 36% of acrylonitrile amount and 80% of hydrogenation ratio (produced by Nihon Zeon Corp.): 100 parts,

Strontium-ferrite having an average particle size of 1.1 μm (produced by Toda Kogyo Corp): 870 parts,

KBM803 (produced by Shinetsu Kagaku Corp) as a silane coupling agent: 1 part,

Paraffin 170° F. (produced by Nihon Seirou Corp) as a lubricating agent: 3 parts,

Sulfur (produced by Hosoi Kagaku Corp.): 0.5 part,

N-cyclohexyl benzothiazyl-2-sulfenamide (produced by Sanshin Kagaku Kogyo Corp.): 1.5 parts, Tetramethyl thiuramdisulfide (produced by Sanshin Kagaku Kogyo Corp): 1 part, and N-(cydohexyl thio) phthalimide (produced by Sanshin Kagaku Kogyo Corp.): 0.3 part as vulcanization promoting agents,

Active zinc white (produced by Sakai Kagaku Kogyo Corp.): 4 parts and Stearic acid (produced by Kao Corp.): 3 parts as vulcanization promoting auxiliary agents,

Nau Guard 445 (produced by Uni Royal Chemical Corp.): 1.5 parts as a antioxidant, and

Polyester based plasticizer (produced by Dai Nippon Ink Corp.): 3 parts

The above-mentioned kneaded product shaped into a sheet-like form was molded and vulcanized at 190° C. for 3 minutes. Thereafter, secondary vulcanization was applied at 180° C. for 1 hour. A sheet-like magnetic rubber composition la of example of the present invention was obtained.

Moreover, in addition thereto, above-mentioned kneaded product shaped into a rope-like form was placed on a metal ring with a phenol based adhesive applied, and then molded and vulcanized at 190° C. for 3 minutes. Thereafter, secondary vulcanization was applied at 180° C. for 1 hour. A metal ring 1b on which a magnetic rubber composition of example of the present invention was bonded was obtained. This magnetic rubber composition has 72.5 mm outer diameter, 59.1 mm inner diameter, and 0.9 mm thickness.

### Example 2

Using hermetically sealed type kneading machine, with a temperature preset at 90° C., following materials were added and kneaded at one time

Hydrogenated nitrile butadiene rubber with 36% of acrylonitrile amount and 80% of hydrogenation ratio (produced by Nihon Zeon Corp.): 100 parts,

Carbon black having a particle size of 30 nm (produced by Ketchen Black International Corp.): 10 parts,

Strontium-ferrite having an average particle size of 1.1 μm (produced by Toda Kogyo Corp): 870 parts,

KBM803 (produced by Shinetsu Kagaku Corp) as a silane coupling agent: 1 part,

paraffin 170° F. (produced by Nihon Seirou Corp) as a lubricating agent: 3 parts,

Sulfur (produced by. Hosoi Kagaku Corp.): 0.5 part,

N-cyclohexyl benzothiazyl-2-sulfenamide (produced by Sanshin Kagaku Kogyo Corp.): 1.5 parts, Tetramethyl thiuramdisulfide (produced by Sanshin Kagaku Kogyo Corp.): 1 part, and N-(cyclohexyl thio) phthalimide (produced by Sanshin Kagaku Kogyo Corp.): 0.3 part as vulcanization promoting agents,

Active zinc white (produced by Sakai Kagaku Kogyo Corp.): 4 parts and Stearic acid (produced by Kao Corp.): 3 parts as vulcanization promoting auxiliary agents,

Nau Guard 445 (produced by Uni Royal Chemical Corp.): 1.5 parts as a antioxidant, and

Polyester based plasticizer (produced by Dai Nippon Ink Corp.): 3 parts

The above-mentioned kneaded product shaped into a sheet-like form was molded and vulcanized at 190° C. for 3 minutes. Thereafter, secondary vulcanization was applied at 180° C. for 1 hour. A sheet-like magnetic rubber composition 2a of example of the present invention was obtained.

Moreover, in addition thereto, the above-mentioned kneaded product shaped into a rope-like form was placed on a metal ring with a phenol based adhesive applied, and then molded and vulcanized at 190° C. for 3 minutes. Thereafter, a secondary vulcanization was applied at 180° C. for 1 hour. A metal ring 2b on which a magnetic rubber composition of example of the present invention was bonded was obtained. This magnetic rubber composition has 72.5 mm outer diameter, 59.1 mm inner diameter, and 0.9 mm thickness.

### Example 3

In the same operation as in the example 1 except that 870 parts of barium-ferrite having an average particle size of 1.3 μm (produced by Toda Kogyo Corp.) was used instead of 870 parts of the strontium-ferrite having the average particle size of 1.1 μm (produced by Toda Kogyo Corp.), a sheet-like magnetic rubber composition 3a of example of the present invention, and a metal ring 3b on which a magnetic rubber composition of example of the present invention was bonded was obtained.

### Example 4

In the same operation as in the example 2 except that 870 parts of barium-ferrite having an average particle size of 1.3 μm (produced by Toda Kogyo Corp.) was used instead of 870 parts of strontium-ferrite having the average particle size of 1.1 μm (produced by Toda Kogyo Corp.), a sheet-like magnetic rubber composition 4a of an example of the present invention, and a metal ring 4b on which a magnetic rubber composition of example of the present invention was bonded was obtained.

### Example 5

In the same operation as in the example 1 except that 609 parts of strontium-ferrite having an average particle size of 1.1 μm (produced by Toda Kogyo Corp.) and 261 parts of a barium-ferrite having an average particle size of 1.3 μm (produced by Toda Kogyo Corp.) were used instead of 870 parts of strontium-ferrite having average particle size of 1.1 μm (produced by Toda Kogyo Corp.), a sheet-like magnetic rubber composition 5a of an example of the present invention, and a metal ring 5b on which a magnetic rubber composition of example of the present invention was bonded was obtained.

### Example 6

In the same operation as in the example 2 except that 609 parts of a strontium-ferrite having an average particle size of 1.1 μm (produced by Toda Kogyo Corp.) and 261 parts of a barium-ferrite having an average particle size of 1.3 μm (produced by Toda Kogyo Corp.) were used instead of 870 parts of the strontium-ferrite having the average particle size of 1.1 μm (produced by Toda Kogyo Corp.), a sheet-like magnetic rubber composition 6a of example of the present invention, and a metal ring 6b on which a magnetic rubber composition of example of the present invention was bonded was obtained.

### Test Example

(1) Using the sheet-like magnetic rubber compositions 1a to 6a of the examples of the present invention, the magnetic characteristic, the ordinary state physical property, the heat resistance, the water resistance, and the grease resistance were evaluated.

The magnetic characteristic was measured by a VSM (vibration specimen type magnetometer).

The ordinary state physical property was measured based on Japanese Industrial Standard (JIS). That is, it was measured by a tensile tester using a dumbbell specimen punched out from the sheet.

The heat resistance was measured based on Japanese Industrial Standard. That is, a dumbbell specimen punched out from the sheet, thermally deteriorated by a gear type oven was measured.

The water resistance was measured based on the Japanese Industrial Standard. That is, a dumbbell specimen punched out from the sheet, soaked in hot water was measured.

The grease resistance was measured based on the Japanese Industrial Standard. That is, a dumbbell specimen punched out from the sheet, soaked in a grease was measured.

(2) The metal rings 1b to 6b, with a magnetic rubber composition of an example of the present invention was bonded and formed and subsequent to magnetization of each of the 48 NS poles, the polar flux density of each magnetic pole was measured by a Hall effect sensor. The average magnetic flux density on the circumference of the encoder and the variation of the magnetic force with respect to the average magnetic flux density were calculated.

Results are shown in the appended table 1.

From the table 1, it was learned that the magnetic rubber compositions (examples 1 to 6) according to the present invention have the heat resistance, the water resistance, and the oil resistance necessary for use as an encoder even in the case where the ferrite content ratio is more than 87%.

Moreover, it was learned that the magnetic rubber compositions (examples 1 to 6) according to the present invention have a magnetic characteristic over (BH)max7.8 KJ/m³, and thus they provide the practical magnetic force required for a magnetic rubber for an encoder.

From the comparison of examples 1 and 2 which contain only strontium-ferrite, examples 3 and 4 which contain only barium-ferrite, and examples 5 and 6 which contain both strontium-ferrite and barium-ferrite, it is learned that it is preferable to contain only strontium-ferrite in terms of further reinforcing the average magnetic flux density on the encoder circumference, it is preferable to contain only barium-ferrite as in examples 3 and 4 in terms of reducing the irregularity of the magnetic force with respect to the average magnetic flux density, and it is preferable to contain both strontium-ferrite and barium-ferrite as in examples 5 and 6 in terms of reducing the variation of the magnetic force with respect to the average magnetic flux density while reinforcing the average magnetic flux density on the encoder circumference.

Moreover, from the comparison of examples 1 and 2, examples 3 and 4, and examples 5 and 6, it is learned that the ordinary state physical property, such as hardness, tensile strength, and stretch can be improved by containing a carbon black in all of the cases where only strontium-ferrite is contained, only barium-ferrite is contained, and both strontium-ferrite and barium-ferrite are contained.

### INDUSTRIAL APPLICABILITY

As heretofore mentioned, the magnetic rubber composition for encoder according to the present invention can be used in the field wherein an accurate magnetization pitch is required, and it is suitable for the case where the heat resistance, the weather resistance, the oil resistance and the water resistance are required.

Therefore, it is useful as a magnetic rubber to be used for encoder for the rotational frequency measurement, or the like.

TABLE 1

| | | Example 1 | Example 2 | Example 3 | Example 4 | Example 5 | Example 6 |
|---|---|---|---|---|---|---|---|
| H-NBR | | 100 | 100 | 100 | 100 | 100 | 100 |
| (hydrogenation 80%) | | | | | | | |
| Strontium-ferrite | | 870 | 870 | — | — | 609 | 609 |
| Barium-ferrite | | — | — | 870 | 870 | 261 | 261 |
| Silane coupling agent | | 1 | 1 | 1 | 1 | 1 | 1 |
| Lubricating agent | | 3 | 3 | 3 | 3 | 3 | 3 |
| Vulcanization agent (sulfur) | | 0.5 | 0.5 | 0.5 | 0.5 | 0.5 | 0.5 |
| Carbon black | | — | 10 | — | 10 | — | 10 |
| Vulcanization | CM | 1.5 | 1.5 | 1.5 | 1.5 | 1.5 | 1.5 |
| promoting agent | TT | 1.0 | 1.0 | 1.0 | 1.0 | 1.0 | 1.0 |
| | PVI | 0.3 | 0.3 | 0.3 | 0.3 | 0.3 | 0.3 |
| Vulcanization | Active zinc white | 4 | 4 | 4 | 4 | 4 | 4 |
| promoting | Stearic acid | 3 | 3 | 3 | 3 | 3 | 3 |
| auxiliary agent | | | | | | | |
| Antioxidant | | 1.5 | 1.5 | 1.5 | 1.5 | 1.5 | 1.5 |
| Polyester based plasticizer | | 3 | 3 | 3 | 3 | 3 | 3 |
| Ferrite content ratio (%) | | 88.0 | 87.1 | 88.0 | 87.1 | 88.0 | 87.1 |
| Magnetic characteristic | | 12.3 | 11.5 | 8.2 | 7.8 | 9.9 | 9.2 |
| (BH)max/kJ · m⁻³ | | | | | | | |
| Ordinary | Hardness (pts) | 96 | 97 | 92 | 93 | 94 | 96 |
| state physical | Tensile strength | 4.8 | 5.1 | 4.6 | 5.2 | 4.9 | 5.4 |
| property | (Mpa) | | | | | | |
| | Stretch (%) | 22 | 45 | 23 | 52 | 21 | 46 |
| Heat | Hardness change | +3 | +2 | +4 | +3 | +3 | +2 |
| resistance | (pts) | | | | | | |
| (150° C. for | Tensile strength | +102 | +90 | +88 | +95 | +104 | +101 |
| 168 hours) | change ratio (%) | | | | | | |
| | Stretch change | −23 | −20 | −23 | −30 | −25 | −26 |
| | ratio (%) | | | | | | |
| Water | Hardness change | −4 | −2 | −3 | −2 | −4 | −2 |
| resistance | (pts) | | | | | | |
| (70° C. for | Volume change | +4.2 | +3.6 | +4.1 | +3.8 | +4.1 | +3.4 |
| 68 hours) | ratio (%) | | | | | | |
| Grease | Hardness change | −3 | −2 | −3 | −3 | −4 | −3 |
| resistance | (pts) | | | | | | |
| (120° C. for | Volume change | +1.4 | +0.8 | +1.1 | +0.7 | +1.3 | +0.8 |
| 168 hours) | ratio (%) | | | | | | |

| | | | | | | |
|---|---|---|---|---|---|---|
| Average magnetic flux density on | 58.0 | 55.9 | 46.6 | 43.6 | 55.1 | 52.4 |
| circumference of encoder (mT) | | | | | | |
| Variation of magnetic force with | 15.4 | 16.2 | 8.0 | 8.2 | 10.2 | 10.5 |
| respect to average magnetic flux | | | | | | |
| density (%) | | | | | | |

1. A magnetic rubber composition for encoder comprising 300 to 1,800 parts of strontium-ferrite, 0.5 to 2 parts of silane coupling agent, and 1 to 10 parts of lubricating agent, per 100 parts of hydrogenated nitrile butadiene rubber with 15 to 50% of acrylonitrile amount and 80 to 99% of hydrogenation ratio.

2. A magnetic rubber composition for encoder comprising 300 to 1,800 parts of barium-ferrite, 0.5 to 2 parts of silane coupling agent, and 1 to 10 parts of lubricating agent, per 100 parts of hydrogenated nitrile butadiene rubber with 15 to 50% of acrylonitrile amount and 80 to 99% of hydrogenation ratio.

3. A magnetic rubber composition for encoder comprising 300 to 1,800 parts of a mixture of strontium-ferrite and barium-ferrite, 0.5 to 2 parts of silane coupling agent, and 1 to 10 parts of lubricating agent, per 100 parts of hydrogenated nitrile butadiene rubber with 15 to 50% of acrylonitrile amount and 80 to 99% of hydrogenation ratio.

4. The magnetic rubber composition for encoder according to claim 3, characterized in that the mixture of strontium-ferrite and barium-ferrite contains 20 to 50% by weight of barium ferrite.

5. The magnetic rubber composition for encoder according to claim 1, characterized in that the magnetic rubber composition for encoder further contains 0.1 to 10 parts of vulcanization agent per 100 parts of hydrogenated nitrile butadiene rubber with 15 to 50% of acrylonitrile amount and 80 to 99% of hydrogenation ratio.

6. The magnetic rubber composition for an encoder according to claim 1, characterized in that the magnetic rubber composition for encoder further contains 2 to 30 parts of carbon black per 100 parts of the hydrogenated nitrile butadiene rubber with 15 to 50% of acrylonitrile amount and 80 to 99% of hydrogenation ratio.

7. The magnetic rubber composition for encoder according to claim 6, characterized in that particle size of carbon black is 10 to 50 nm.

8. The magnetic rubber composition for encoder according to claim 2, characterized in that the magnetic rubber composition for encoder further contains 0.1 to 10 parts of vulcanization agent per 100 parts of hydrogenated nitrile butadiene rubber with 15 to 50% of acrylonitrile amount and 80 to 99% of hydrogenation ratio.

9. The magnetic rubber composition for encoder according to claim 3, characterized in that the magnetic rubber composition for encoder further contains 0.1 to 10 parts of vulcanization agent per 100 parts of hydrogenated nitrile butadiene rubber with 15 to 50% of acrylonitrile amount and 80 to 99% of hydrogenation ratio.

10. The magnetic rubber composition for encoder according to claim 4, characterized in that the magnetic rubber composition for encoder further contains 0.1 to 10 parts of vulcanization agent per 100 parts of hydrogenated nitrile butadiene rubber with 15 to 50% of acrylonitrile amount and 80 to 99% of hydrogenation ratio.

11. The magnetic rubber composition for an encoder according to claim 2, characterized in that the magnetic rubber composition for encoder further contains 2 to 30 parts of carbon black per 100 parts of the hydrogenated nitrile butadiene rubber with 15 to 50% of acrylonitrile amount and 80 to 99% of hydrogenation ratio.

12. The magnetic rubber composition for an encoder according to claim 3, characterized in that the magnetic rubber composition for encoder further contains 2 to 30 parts of carbon black per 100 parts of the hydrogenated nitrile butadiene rubber with 15 to 50% of acrylonitrile amount and 80 to 99% of hydrogenation ratio.

13. The magnetic rubber composition for an encoder according to claim 4, characterized in that the magnetic rubber composition for encoder further contains 2 to 30 parts of carbon black per 100 parts of the hydrogenated nitrile butadiene rubber with 15 to 50% of acrylonitrile amount and 80 to 99% of hydrogenation ratio.

14. The magnetic rubber composition for an encoder according to claim 5, characterized in that the magnetic rubber composition for encoder further contains 2 to 30 parts of carbon black per 100 parts of the hydrogenated nitrile butadiene rubber with 15 to 50% of acrylonitrile amount and 80 to 99% of hydrogenation ratio.

15. The magnetic rubber composition for encoder according to claim 11, characterized in that particle size of carbon black is 10 to 50 nm.

16. The magnetic rubber composition for encoder according to claim 12, characterized in that particle size of carbon black is 10 to 50 nm.

17. The magnetic rubber composition for encoder according to claim 13, characterized in that particle size of carbon black is 10 to 50 nm.

18. The magnetic rubber composition for encoder according to claim 14, characterized in that particle size of carbon black is 10 to 50 nm.
